(19) United States
(12) Patent Application Publication
(10) Pub. No.: US 2012/0028022 A1
(43) Pub. Date: Feb. 2, 2012

(54) Modified alkoxylation products having at least one non-terminal alkoxysilyl group and used thereof in hardenable compounds with increased storage stability and extensibility

(75) Inventors: Bastian Matthias Brugger, Oberhausen (DE); Tammo Boinowitz, Essen (DE); Frank Schubert, Neukirchen-Vluyn (DE); Melanie Roessing, Oberhausen (DE); Matthias Lobert, Essen (DE)

(73) Assignee: Evonik Goldschmidt GmbH, Essen (DE)

(21) Appl. No.: 13/195,049

(22) Filed: Aug. 1, 2011

(30) Foreign Application Priority Data
Aug. 2, 2010 (DE) 10 2010 038 768.1

(51) Int. Cl. B32B 5/00; B32B 15/02; C08J 9/04; C09J 171/02; C08G 65/336; C09D 171/02

(52) U.S. Cl. 428/221; 525/409; 524/612; 521/189; 428/407

(57) ABSTRACT

Modified alkoxylation products of formula (I), application thereof and methods of production thereof

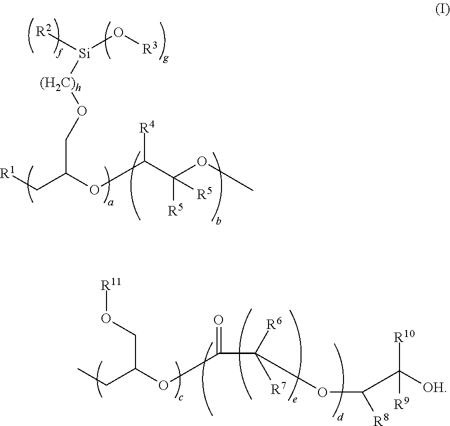

Any foregoing applications, including German patent application DE 10 2010 038 768.1, filed on 2 Aug. 2010 and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

Alkoxylation products, such as polyethers for example, which bear alkoxysilyl groups, where at least one alkoxysilyl group is distributed in block fashion or randomly, non-terminally in the chain of the polyether and where the polyether chain has at least one terminal OH group, should have sufficient storage stability in a sealant or adhesive formulation.

The invention relates to novel alkoxylation products bearing alkoxysilyl groups, mostly in the form of copolymers containing (poly)ether alcohols or polyether blocks, which are characterized in that the reactivity of the hydroxyl function is reduced, and methods of production thereof and use thereof.

Conventional polyether alcohols, often also simply called polyethers and mainly made up of propylene oxide and ethylene oxide, have been known for a long time and are produced industrially in large amounts. They are used, among other things, by reaction with polyisocyanates, as starting compounds for the production of polyurethanes or also for the production of surfactants.

Organic alkoxysilane compounds such as 3-glycidyloxy-propyltrimethoxy- or -triethoxysilane, which are available for example under the trade names DYNASYLAN® GLYMO or DYNASYLAN® GLYEO (trademarks of Evonik Degussa GmbH), are finding application in the production of organically modified networks in the sol-gel process, which serves as a key process for the production of nanocomposites, which provide coating systems with improved properties with respect to hardness, scratch and abrasion resistance, temperature resistance and resistance to solvents and acids. Furthermore, alkoxysilane compounds are finding varied applications in sealants and adhesives and generally as reactive adhesion promoters and primers for various substrates such as metals, glass and glass fibres/glass cloth for fibre-reinforced composites and for surface treatment of e.g. pigments and fillers in paints.

There has been no lack of effort for improving the property profiles of alkoxysilane compounds by chemical modifications, in order to open up yet more applications for this important product class. Thus, combining the property profile of alkoxylation products (polyethers) with those of crosslinkable compounds, especially those bearing alkoxysilyl groups, is known from the literature. Thus, EP 0 918 062 relates to, among other things, the modification of polyether alcohols with e.g. alkoxysilanes bearing isocyanate groups with urethanizing crosslinking. Moreover, the hydrosilylating attachment of alkoxymonohydridosilanes to polyetherols modified beforehand with olefinically unsaturated end groups is also selected for alkoxysilyl modification.

Documents JP 09012863, JP 09012861 and JP 07062222 claim a method of production of polyetherols provided exclusively terminally with hydrolysable trialkoxysilyl functions, e.g. glycerol polyetherols, which first are produced via DMC catalysis, and then by adding alkali alcoholate and allyl chloride are converted to the corresponding allyl ethers and then by platinum-metal-catalysed hydrosilylation to the alkoxysilyl-terminated target products.

All the methods described in the prior art are thus only suitable for the production of polyoxyalkylene compounds modified exclusively terminally with trialkoxysilyl groups and not at all for the single and/or multiple modification of polyether chains with trialkoxy functions also within the sequence of oxyalkylene units.

According to EP 2 093 244 (US 2010-0041910), for the first time it was possible to produce alkoxysilyl group-bearing alkoxylation products that are characterized in that, in contrast to the previously known prior art, the alkoxysilyl groups are distributed block-like or randomly along the polyether chain and are not only located on the chain ends. Furthermore, these compounds are characterized by a terminal OH group due to the reaction.

The intrinsic reactivity of the compounds and easy crosslinkability with formation of three-dimensional polymeric networks arises from the presence of the OH group and the hydrolysis-sensitive alkoxysilyl groups in a molecule. However, tests have also shown that the reactivity of the OH group may be too high.

The resultant formulations have insufficient storage stability. They crosslink even at slightly elevated temperature (to 60° C.) within a few days in the presence of the metal and/or amine catalysts typically used in moisture-curing formulations.

Even if residual moisture in the formulation seems to promote crosslinking, it has been shown that even in very dry conditions the formulation starts to crosslink within a few days in the accelerated storage test.

The problem facing the present invention is therefore to lower the reactivity of the OH group of hydroxyl-group-terminated alkoxylation products bearing not exclusively terminal alkoxysilyl groups.

It was shown, surprisingly, that by reducing the reactivity of the OH groups, the storage stability and surprisingly also the ultimate elongation of the cured/polymerized alkoxysilylated alkoxylation product can be massively improved. The products of the invention have undetectable amounts of free epoxy groups when using conventional analytical techniques in the art.

The problem is solved by the introduction of a space-filling hydroxyl-functionalized group on the chain end of the prepolymer. These structures modified in this way can be present alone or mixed with unmodified structures or can be used together with other hardenable compounds of a different nature.

The invention therefore relates to alkoxylation products of general formula (I)

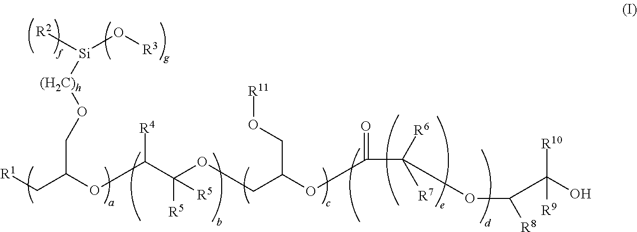

where
R¹=a 1- to 6-fold functional saturated or unsaturated, linear or branched organic residue of the type of an alkoxy, arylalkoxy or alkarylalkoxy group, in which the carbon chain can be interrupted by oxygen atoms and can also bear substituents containing alkoxysilyl side groups or is substituted directly with alkoxysilyl groups, corresponds to a polyoxyalkylene residue, a polyether residue, a polyetheralkoxy residue or a singly or multiply annelated phenolic group or can be derived from a singly or multiply hydroxylated or multiply substituted compound selected from the group comprising alcohols, polyetherols, polyesterols, siloxanes, perfluorinated polyetherols, (poly)-urethanes or sugars, the following being preferred: polyols, EO-polyetherols, PO-polyetherols or EO/PO-polyetherols, polyesterols, glycerol, polyglycerol, polyTHF, phenol, alkyl and aryl phenols, bisphenol A, novolacs, hydroxycarboxylic acids, siloxanols, siloxane diols, polyetherols modified with alkoxysilyl groups, castor oil, ricinoleic acid, sugars, lactones, cellulose, methanol, ethanol, n-, i-propanol, n-, i-, or t-butanol, 2-butanol, octanol, allyl alcohol, dodecanol, stearyl alcohol, 2-ethylhexanol, cyclohexanol, benzyl alcohol, ethylene glycol, propylene glycol, di-, tri- and polyethylene glycol, 1,2-propylene glycol, di- and polypropylene glycol, OH-functional polyolefins such as OH-functional polybutadiene, 1,4-butanediol, 1,6-hexanediol, 1,4-butynediol, tetramethyldecinediol, trimethylolpropane, pentaerythritol, sorbitol, cellulose sugars, lignin or also other compounds bearing hydroxyl groups based on natural substances, or other hydroxy compounds which can themselves also bear alkoxysilyl groups or bear substituents that are substituted with alkoxysilyl groups,
R²=an alkyl group with 1 to 8 carbon atoms, in particular methyl or ethyl,
R³=an alkyl group with 1 to 8 carbon atoms, in particular methyl, ethyl, propyl, i-propyl,
R⁴=a hydrogen radical or an alkyl group with 1 to 8 carbon atoms, preferably methyl or ethyl,
R⁵=independently of one another a hydrogen radical, an alkyl group with 1 to 20 carbon atoms, an aryl or alkaryl group, preferably hydrogen, methyl, ethyl, octyl, decyl, dodecyl, phenyl, benzyl, especially preferably hydrogen, methyl or ethyl,
R¹¹=a saturated or unsaturated alkyl group with 1 to 8 carbon atoms, whose chain can be interrupted by oxygen and can bear further functional groups such as carboxyl groups or ester groups, an aryl group with 6 to 20 carbon atoms, an alkaryl group with 7 to 20 carbon atoms, preferably a methyl, ethyl, phenyl or benzyl group or an allyl group or a polyacrylic acid ester
R⁶ and R⁷=independently of one another are equal to R⁵,
R⁸ and R⁹=independently of one another are equal to R⁴,
R¹⁰=R⁴ with the proviso
that if R⁹=H, then R¹⁰ is equal to an alkyl group with 2 to 8 carbon atoms and if R⁹=methyl, then R¹⁰ is an alkyl group with 1 to 8 carbon atoms, in any case not equal to hydrogen;
a=0 to 1000, preferably 0 to 50 and especially preferably 0 to 10, provided that “a” must be greater than or equal to 1, if R¹ does not bear any substituents with alkoxysilyl groups or itself is not directly substituted with alkoxysilyl groups,
b=0 to 1000, preferably 1 to 800, especially preferably 30 to 500 and in particular 80 to 300,
c=independently of one another equal to b,
d=independently of one another equal to b,
provided that the groups with the indices a, b, c and d can be freely permuted over the molecular chain and can be present singly or multiply and can be distributed as blocks one after another or randomly over the molecular chain
e=1 to 10, preferably 1 to 5,
g+f=3 and g is at least equal to 1,
h=0, 1, 2, 3, 4, 5, 6, 7, 8, 9 or 10.

Preferably the alkoxylation product of formula (I) bears an end block of alkoxylated butylene oxide —(C₄H₉O)ₙH with n=1 to 100, preferably 2 to 50 and in particular 5 to 20.

The average molecular weights M_{w} of the compounds of formula (I) thus produced are between 8000 and 40 000 g/mol, preferably between 10 000 and 20 000 g/mol. Preferably the compounds of formula (I) are liquid at room temperature.

The products of formula (I) can be used alone or also together with alkoxylation products that do not have the end group functionalization according to the invention. If mixtures are used, then in compositions containing both species the percentage weight ratio of the end-group-modified compounds of formula (I) to their unmodified precursors is between 100:0 and 10:90, preferably between 95:5 and 15:85 and in particular between 80:20 and 30:70.

The various monomer units both of the fragments with the indices a, b, c, and d and of the optionally present polyoxyalkylene chain of the substituent R¹ can be built up as blocks with one another or alternatively can be subject to a random distribution and moreover are freely permuted with one another. The succession of the monomer units in the resultant molecule depends solely on the order of metering and the reactivity of the underlying molecules.

The index numbers shown in the formulae given here and the ranges of values of the indices shown are therefore to be understood as the mean values of the possible statistical distribution of the actual structures present and/or mixtures thereof. This also applies to structural formulae represented in themselves as exact, for example as in formula (I).

The invention further relates to hardenable compositions in the form of formulations as constituents of compounds that are hardenable under the action of water or moisture, which contain at least one of the products according to the invention alone or mixed with other, optionally identical hardenable substances.

The formulations can be in the form of a solution, emulsion, dispersion or also suspension. Moreover, in for example aqueous emulsions or suspensions, there may also be partial hydrolysates and therefore partially polymerized species where crosslinking has started, derived from the compounds of formula (I). These partial hydrolysates in suspension or emulsion are suitable in particular for the hydrophobization of flat substrates, for example in building conservation.

Moreover, the products described in EP 2 093 244 can also be used in any mixtures with the structures presented here, the structures according to the present invention advantageously having a proportion of at least 20 wt. %, preferably at least 50 wt. % in said mixtures. The formulations obtainable in this way can in addition contain diluents, catalysts, plasticizers, fillers, solvents, adhesion promoters, additives for adjusting flow behaviour, so-called rheology additives, additives for chemical drying, and/or stabilizers against thermal and/or chemical stresses and/or stressing by ultraviolet and visible light, thixotropic agents, flame retardants, foaming agents or antifoaming agents, deaerators, film-forming polymers, anti-microbial agents and preservatives, antioxidants, colorants, dyes and pigments, antifreezes, fungicides, reactive thinners, chelating agents, wetting agents, co-crosslinking agents, spraying aids, vitamins, growth promoters, hormones, pharmacological active substances, odorants, radical interceptors and/or other additives.

It is described in EP 2 093 244 that alkoxysilanes bearing epoxy functions can be selectively alkoxylated advantageously in the presence of known double metal cyanide catalysts. The method claimed there opens up the possibility of reproducible single and/or multiple alkoxysilyl group modification of polyoxyalkylene compounds not only terminally, but also within the sequence of oxyalkylene units. The disclosure in paragraphs [0007] to [00043] of EP 2 093 244 is therefore to be regarded in its entirety as an integral part of this description.

A disadvantage of the alkoxysilylated products described there is however their low storage stability when used in hardenable compounds.

The structures described here with formula (I) solve the problem of inadequate storage stability.

Preferably, the products according to the invention can be obtained via an alkoxylation process using double metal cyanide catalysts (DMC catalysts). These catalysts have been known, in their production and use as alkoxylation catalysts, since the 1960s and are presented for example in U.S. Pat. No. 3,427,256, U.S. Pat. No. 3,427,334, U.S. Pat. No. 3,427,335, U.S. Pat. No. 3,278,457, U.S. Pat. No. 3,278,458 or U.S. Pat. No. 3,278,459. The increasingly more effective types of DMC catalysts developed further in subsequent years and described for example in U.S. Pat. No. 5,470,813 and U.S. Pat. No. 5,482,908 include the special zinc-cobalt-hexacyano complexes. Because of their extraordinarily high activity, only small catalyst concentrations are required for the production of polyetherols, so that it is possible to dispense with the finishing stage required for conventional alkaline catalysts—consisting of neutralization, precipitation and filtration of the catalyst—at the end of the alkoxylation process. The fact that for example propylene oxide-based polyethers only contain very small proportions of unsaturated by-products can be attributed to the high selectivity of DMC-catalysed alkoxylation.

Reference may also be made for example to EP-A1-1 017 738 (U.S. Pat. No. 6,077,978), U.S. Pat. No. 5,777,177, EP-A1-0 981 407 (U.S. Pat. No. 5,844,070), WO 2006/002807 (US 2007-225394) and EP-A1-1 474 464 (US 2005-159627).

Another object of the invention is therefore a method of production of alkoxylation products bearing alkoxysilyl groups of formula (I) using DMC catalysis from starting compounds R¹—H bearing hydroxyl groups, in which in an alkoxylation reaction, first optionally alkylene oxides, epoxy-functional alkoxysilanes, glycidyl compounds and/or lactones are added on in any order and in a final alkoxylation step at least one monomer unit of an epoxide of formula (Ia)

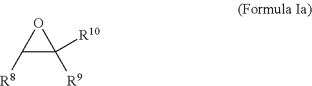

where
R⁸ and R⁹=a hydrogen radical or an alkyl group with 1 to 8 carbon atoms, preferably methyl or ethyl,
R¹⁰=a hydrogen radical or an alkyl group with 1 to 8 carbon atoms, preferably methyl or ethyl,
with the proviso
that if R⁹=H, then R¹⁰ is equal to an alkyl group with 2 to 8 carbon atoms and if R⁹=methyl, then R¹⁰ is an alkyl group with 1 to 8 carbon atoms, in any case different from hydrogen,
is added on to the OH function of the polymer chain.

Preferably at least one substituted epoxide is used alone or in any mixtures with other epoxides with the same structure, which has a linear or branched alkyl group with 2 to 30 carbon atoms as substituent R⁸, R⁹ or R¹⁰.

Especially preferably, butylene oxide or isobutylene oxide is used in the last alkoxylation step.

The resultant longer-chain end block, preferably consisting of butylene oxide polymerized into the molecule, of the prepolymer thus produced probably contributes to steric shielding of the terminal OH function of these molecules.

Depending on the epoxy-functional alkoxysilane used and any other monomers used, modified alkoxylation products (I) can be produced, as well as mixtures constituted in any way.

A non-exhaustive list of alkoxysilanes substituted with epoxy groups, which can be used alone or mixed with one another or in combination with epoxy compounds within the scope of the invention, comprises for example 3-glycidyloxypropyltrimethoxysilane, 3-glycidyloxypropyl-triethoxysilane, 3-glycidyloxypropyltripropoxysilane, 3-glycidyloxypropyltriisopropoxysilane, bis(3-glycidyl-oxypropyl)dimethoxysilane, bis(3-glycidyloxypropyl)diethoxysilane, 3-glycidyloxyhexyltrimethoxysilane, 3-glycidyloxyhexyltriethoxysilane, 3-glycidyloxypropyl-methyl-dimethoxysilane, 3-glycidyloxypropyl-ethyl-diethoxysilane.

The compounds that supply the residue R¹ of formula (I) are to be understood, within the scope of the present invention, to be substances that form the beginning (start) of the alkoxylation product to be produced, which is obtained by the adding-on according to the invention of epoxy-functional monomers of the comonomers and possibly other comonomers. The starting compound used in the method according to the invention is preferably selected from the group comprising alcohols, polyetherols or phenols. A mono- or polyvalent polyether alcohol or alcohol R¹—H (the H belongs to the OH group of the alcohol or phenol) is preferably used as the starting compound.

Compounds with molecular weights from 31 to 10 000 g/mol, in particular 50 to 2000 g/mol and with 1 to 8, preferably with 1 to 4 hydroxyl groups are preferably used as OH-functional starting compounds R¹—H. The starting compounds can be used in any mixtures with one another or as the pure substance. Hydroxy compounds substituted laterally with substituents containing alkoxysilyl groups or directly with alkoxysilyl groups, such as the silyl polyethers described in EP 2093244, can also be used as starting compounds.

Advantageously, low-molecular polyetherols with 1-8 hydroxyl groups and molecular weights from 50 to 2000 g/mol, which for their part were produced previously by DMC-catalysed alkoxylation, are used as starter compounds.

In addition to compounds with aliphatic and cycloaliphatic OH groups, any compounds with 1-20 phenolic OH functions are suitable. These include for example phenol, alkyl and aryl phenols, bisphenol A and novolacs.

By means of the method according to the invention, modified alkoxylation products are prepared, which are characterized in that they can be produced in a targeted manner with respect to structure and molecular weight and reproducibly, are stable in storage and can be processed excellently under the action of moisture to an adhesive and/or a sealant, which preferably has elastic properties. The fragments that are inserted in the resultant modified polymer chain by the alkoxylation reaction with ring opening of the reaction components of the starters, of an organic hydroxy compound, and various epoxides, which can be used in mixtures and at least a certain proportion of which bears alkoxysilyl groups, are freely permutable with one another in their sequence.

With the method introduced here according to the invention, for the first time a method is offered for the production of adhesives and sealants that are commercially usable and are stable in storage, from alkoxylation products that bear alkoxysilyl groups not exclusively terminally and that optionally can also be used for coatings or for the surface treatment of flat or particulate substrates and objects.

Thus, the method according to the invention makes it possible to construct novel prepolymer systems, which can thus not be derived from the prior art, crosslinking of which leads to polymers which therefore also reflect a novel structure. Simple insertion of a polymer fragment, which does not have alkoxysilyl groups, between the chain and/or terminal functionalizations obtained according to the invention and a polymer residue that is not further specified, and has long been known, therefore cannot possibly lead to the prepolymers according to the subject matter of the invention.

The reaction is carried out at temperatures from 60° C. to 150° C.; temperatures from 75° C. to 150° C. are preferred, temperatures from 80° C. to 140° C. are especially preferred, and a reaction temperature of at first 115° C. to 140° C. until incorporation of the monomers bearing alkoxysilyl groups, and then a temperature from 80° C. to 110° C. after incorporation of the monomers bearing alkoxysilyl groups and for the remaining reaction time, are quite especially preferred.

The compositions and mixtures according to the invention, hardenable under the action of moisture, preferably containing at least one component of formula (I), can for example be used as adhesives and/or sealants for the coating and modification of flat, particulate, fibrous substrate surfaces or fabrics. The coating can for example be an adhesive coating, optionally also a foamed adhesive coating. The hardenable composition can also be used in the form of an emulsion, dispersion, suspension or solution, preferably as an aqueous emulsion. This aqueous emulsion can contain partially hydrolysed, partially crosslinked oligomers or (partially) polymeric subsequent products of the hydrolysis or curing reaction of the compounds of formula (I).

Another object of the invention is therefore the use of the products of formula (I) according to the invention in compositions as a constituent of formulations as adhesive or sealant or for the purpose of coating substrates.

These novel, reactive modified alkoxylation products according to the invention constitute, on account of their alkoxysilyl groups that are sensitive to hydrolysis and have a tendency to undergo crosslinking, hardenable modified polymers or oligomers. The crosslinking to solid thermosetting, or depending on the choice of crosslink density or certain additives, also elastomeric or thermoplastic end products, takes place in a simple manner in the presence of water and optionally with addition of acid or base as accelerator. By varying, for example increasing, the temperature during the curing process, the pot life can be controlled, for example shortened. Thus, for example by varying the proportion of alkoxysilane units in the modified polymer chain, the crosslink density and therefore the profile of mechanical and physicochemical properties of the cured modified polymer can be influenced over a wide range.

This hardenable composition consists of the alkoxylation product of formula (I) produced according to the specification given above and further additives selected from the group comprising plasticizers, fillers, solvents, emulsifiers, adhesion promoters, additives for adjusting the flow behaviour, so-called rheology additives and at least one curing catalyst. Moreover, if required, additives for chemical drying, and/or stabilizers against thermal and/or chemical stresses and/or stressing by ultraviolet and visible light can be included in the formulation.

Furthermore, functional substances that are known per se, such as water absorbers, thixotropic agents, flame retardants, foaming agents or antifoaming agents, deaerators, film-forming polymers, antimicrobial agents and preservatives, antioxidants, colorants, dyes and pigments, antifreezes, fungicides, adhesion promoters and/or reactive thinners and plasticizers and chelating agents, spraying aids, wetting agents, vitamins, growth promoters, hormones, pharmacological active substances, odorants, light stabilizers, radical interceptors, UV-absorbers and/or additional stabilizers can also be added to the compositions.

The alkoxylation products made by the method according to the invention can be used alone, or mixed with an alkoxylation product prepared according to EP 2 093 244, and the proportion of the alkoxylation product prepared by the method mentioned in this document should be >20 wt. %, preferably >50 wt. % and especially preferably >75 wt. %.

The plasticizers are selected from the group comprising phthalates, polyesters, phenol alkylsulphonates, cyclohexane-dicarboxylic acid esters or also polyethers, and their proportion in the formulation can be 0 wt. % to 90 wt. %, preferably 2 wt. % to 70 wt. %, especially preferably 5 wt. % to 35 wt. %. Precipitated or ground chalk, precipitated or ground silicates, precipitated or pyrogenic silicas, powdered glass, glass beads, hollow glass beads (called bubbles), metal oxides, e.g. TiO₂, Al₂O₂, metal hydroxides, e.g. aluminium hydroxide, wood flour, natural or precipitated barium sulphates, reinforcing fibres, e.g. glass fibres or carbon fibres, long-fibre or short-fibre wollastonites, cork, carbon black or graphite can be used as fillers. The fillers are preferably used at a concentration from 0 to 90 wt. % relative to the finished mixture, with concentrations from 5 to 70 wt. % being especially preferred. It is also advantageous to use hydrophobized fillers, as these products introduce little water and improve the storage stability of the formulations. Many of the stated fillers can either be hydrophobized subsequently or can be produced in hydrophobized form by suitable process management, or can even be hydrophobized by the alkoxylation products according to the invention. The methods of hydrophobization are varied and are known by a person skilled in the art.

The mixtures can contain organic substances, preferably liquids and solvents. The solvents serve for example for lowering the viscosity of the uncrosslinked mixtures and they promote application on the particle surface. Basically all solvents and solvent mixtures can be considered as solvents. Preferred examples of said solvents are ethers, e.g. t-butyl-methyl ether, esters, e.g. ethyl acetate or butyl acetate or diethyl carbonate and alcohols, e.g. methanol, ethanol and the various regioisomers of propanol and butanol or also types of glycols selected for specific applications. Furthermore, it is also possible to use aromatic and/or aliphatic solvents as well as halogenated solvents, e.g. dichloromethane, chloroform, tetrachloromethane, fluorohydrocarbons (FREON) and many others, but also inorganic solvents, for example water, CS₂, super-critical CO₂ and many others.

The rheology additives can be selected from the group comprising amide waxes, obtainable for example from Cray Valley under the trade name Crayvallac®, cured vegetable oils and fats, pyrogenic silicas, e.g. Aerosil® R202 or R805 (both available from Evonik) or Cab-O-Sil® TS 720 or TS 620 or TS 630 (marketed by Cabot). Depending on the desired flow behaviour, these additives are used in a proportion of 0 wt. % to 10 wt. %, preferably in a proportion of 2 wt. % to 5 wt. % of the total formulation. As chemical drying agents, it is possible to use vinyl trimethoxysilane (Dynasylan® VTMO, Evonik or Geniosil® XL 10, Wacker AG), vinyl triethoxysilane (Dynasylan® VTEO, Evonik or Geniosil® GF 56, Wacker), vinyl triacetoxysilane (Geniosil® GF 62, Wacker), N-trimethoxysilylmethyl-O-methyl-carbamate (Geniosil® XL 63, Wacker) N-dimethoxy(methyl)-silylmethyl0-O-methyl-carbamate, N-methyl[3-(trimethoxysilyl)-propyl]carbamate (Geniosil® GF 60, Wacker), vinyl dimethoxymethylsilane (Geniosil® XL 12, Wacker), vinyl tris(2-methoxyethoxy)silane (Geniosil® GF 58, Wacker) bis(3-triethoxysilylpropyl)amine (Dynasylan® 1122, Evonik), bis(3-trimethoxysilylpropyl)amine (Dynasylan® 1124), N-dimethoxy(methyl)silylmethyl-β-methyl-carbamate (Geniosil® XL 65, Wacker) or oligomeric vinyl silanes, for example Dynasylan® 6490 and Dynasylan® 6498 (both available from Evonik), alone or mixed. The concentration used is based on the degree of stabilization and the effectiveness of the drying agent, preferably with a proportion in the total formulation from 0 to 5 wt. % and especially preferably with a proportion from 0.2 to 3 wt. %. Moreover, a physical drying agent, e.g. zeolites, molecular sieves, anhydrous sodium sulphate or anhydrous magnesium sulphate, can be used in addition to or as an alternative to chemical drying. Substances that are known by a person skilled in the art are used as adhesion promoters, mainly compounds bearing alkoxysilyl groups that additionally have primary or secondary amine groups, vinyl groups, thiol groups, aryl groups or alternatively oxirane groups, such as 3-aminopropyltrimethoxysilane (Dynasylan® AMMO (Evonik), N-(2-aminoethyl)-3-aminopropyltrimethoxysilane (Dynasylan® DAMO (Evonik)), 3-mercaptopropyltrimethoxysilane (Dynasylan® MTMO, Evonik), 3-glycidylpropyltriethoxysilane (Dynasylan® GLYEO, Evonik) glycidylpropyltrimethoxysilane (Dynasylan® GLYMO, Evonik), phenyltrimethoxysilane (Dynasylan® 9165 or Dynasylan® 9265, Evonik) or oligomeric amino/alkyl-alkoxysilanes, e.g. Dynasylan® 1146 (Evonik), in each case alone or mixed. Products that are known by a person skilled in the art or product combinations from e.g. Tinuvin® stabilizers (Ciba), for example Tinuvin® 1130, Tinuvin® 292 or also Tinuvin® 400, advantageously also in combination, can be used as stabilizers. The amount used is based on the degree of stabilization required. Additionally, co-crosslinkers for increasing mechanical hardness and reducing the tendency to flow can be added to the formulation. Said co-crosslinkers are typically substances that are able to make 3, 4, or more crosslinkable groups available. Examples in the context of this invention are 3-aminopropyltriethoxysilane, tetramethoxysilane or tetraethoxysilane.

The hardenable compositions thus obtained are very suitable for gluing and/or sealing and/or foaming and/or coating of particulate or flat substrates. Another object of the invention is therefore the use of the compounds of formula (I) according to the invention and compositions containing them for use in the building industry or in vehicle construction, for the sealing and gluing of constructional elements and components, and for the coating of porous or non-porous, particulate or flat substrates. The alkoxylation product described in the present invention is suitable as an excellent basis of a hardenable composition for the coating and modification of surfaces, particles and fibres. On the basis of the underlying chemistry, mainly substrates that have polar surfaces are to be preferred. We may mention for example applications on metals, in particular the materials of construction such as iron, steel, special steel and cast iron, ceramic materials, mainly based on solid metal oxides or non-metal oxides or carbides, aluminium oxide, magnesium oxide or calcium oxide, and mineral substrates or organic substrates, cork and/or wood. The composition can also be used for the binding and levelling of uneven, porous or friable substrates, e.g. mineral substrates, chipboard and fibreboard made of wood or cork, composites such as wood composites such as MDF (medium density fibreboard), WPC articles (wood plastic composites), chipboard, cork articles, laminated articles, ceramics, as well as natural fibres and synthetic fibres.

As curing catalysts for the crosslinking or polymerization of the prepolymer mixtures according to the invention or chemical fixing thereof on particulate or macroscopic surfaces, it is possible to use the known polyurethanization, allophanatization or biuretization catalysts, which are known per se by a person skilled in the art, or the catalysts that are known from the literature and are usually employed for the hydrolysis and condensation of alkoxysilanes. These include compounds, for example the organic tin compounds that are usually employed, e.g. dibutyltin dilaurate, dioctyltin dilaurate, dibutyltin diacetylacetonate, dibutyltin diacetate, dibutyltin dioctoate, or dioctyltin diacetylacetonate. Moreover, it is also possible to use zinc salts, such as zinc octoate, zinc acetylacetonate and zinc-2-ethylcaproate, or tetraalkylammonium compounds, such as N,N,N-trimethyl-N-2-hydroxypropylammonium hydroxide, N,N,N-trimethyl-N-2-hydroxypropylammonium-2-ethylhexanoate or choline-2-ethylhexanoate. It is preferable to use zinc octoate (zinc-2-ethylhexanoate) and the tetraalkylammonium compounds, and especially preferably zinc octoate. Furthermore, bismuth catalysts, e.g. Borchi® catalysts, bismuth methanesulphonate, bismuth nitrate, bismuth chloride, triphenyl-bismuth, bismuth sulphide, and preparations with these catalysts—titanates, e.g. titanium(IV) isopropylate, iron(III) compounds, e.g. iron(III)-acetylacetonate, aluminium compounds, such as aluminium triisopropylate, aluminium tri-sec-butylate and other alcoholates and aluminium acetylacetonate, calcium compounds, such as calcium disodium ethylenediaminetetraacetate or calcium diacetylacetonate, or also amines, e.g. triethylamine, tributylamine, 1,4-diazabicyclo[2,2,2]octane, 1,8-di-azabicyclo[5.4.0]undec-7-ene, 1,5-diazabicyclo[4.3.0]-non-5-ene, N,N-bis(N,N-dimethyl-2-aminoethyl)-methylamine, N,N-dimethylcyclohexylamine, N,N-dimethylphenylamine, N-ethylmorpholine etc. or also amines, e.g. triethylamine, tributylamine, 1,4-diazabicyclo[2,2,2]-octane, 1,8-diazabicyclo[5.4.0]undec-7-ene, 1,5-diazabicyclo[4.3.0]non-5-ene, N,N-bis(N,N-dimethyl-2-aminoethyl)-methylamine, N,N-dimethylcyclohexylamine, N,N-dimethylphenylamine, N-ethylmorpholine etc. Organic or inorganic Brønsted acids such as acetic acid, trifluoroacetic acid, methanesulphonic acid, p-toluenesulphonic acid or benzoyl chloride, hydrochloric acid, phosphoric acid, mono- and/or diesters thereof, e.g. butylphosphate, (iso-)propylphosphate, dibutyl-phosphate etc., are suitable as catalysts. Combinations of several catalysts can of course also be used.

The hardenable compositions according to the invention can also contain so-called photolatent bases as catalysts, as described in WO 2005/100482. Photolatent bases are preferably to be understood as organic bases with one or more basic nitrogen atoms, which are at first in a blocked form, and it is only after irradiation with UV light, visible light or IR radiation that they release the basic form, as a result of cleavage of the molecule. The contents of the description and of the claims of WO 2005/100482 are included herewith as a component part of this disclosure.

The catalyst or the photolatent base is used in amounts from 0.001 to 5.0 wt. %, preferably 0.01 to 1.0 wt. % and especially preferably 0.05 to 0.9 wt. % relative to the solids content of the product of the method. The catalyst or the photolatent base can be added in one portion or also in portions or even continuously. Addition of the total amount in one portion is preferred.

The mixtures can preferably contain other generally monomeric silanes, siloxanes bearing hydroxyl groups or solvents as further components.

As further silanes, it is possible in principle to use all silanes, preferably with hydrolysable alkoxy groups, and in particular silanes bearing amine groups or vinyl groups, and those that are described in DE 10 2006 054155 (US 2010-078117) or WO 2005/003201 (US 2007-167598).

Another application according to the invention of the compounds bearing alkoxysilyl groups of formula (I) relates to aqueous emulsions and dispersions. As emulsifiers for said emulsions it is possible in principle to consider all anionic, non-ionic, cationic and amphoteric emulsifiers and emulsifier mixtures. Emulsifiers that have a side chain compatible with the alkoxylation product and a hydrophilic moiety are suitable, and in particular those are suitable that have a propoxylated side chain in the hydrophobic moiety, for example EO/PO block copolymers (available for example as Synperonic® (Croda) or Pluronic® (BASF)), which can also be used mixed with ionic or non-ionic emulsifiers.

Other preferred examples of said emulsifiers are alcohol ethoxylates, fatty acid ethoxylates, ethoxylated esters, and (ethoxylated) sorbitan esters. By means of additions and additives, e.g. a water-insoluble plasticizer, the properties of the emulsion can be adjusted to its field of application. Depending on the composition of the hardenable mixture, curing of the emulsified phase, more precisely the alkoxylation product, can take place in aqueous emulsion. This is the case in particular when the hardenable composition is formulated so that even in the presence of water it only hardens slowly and there is therefore time for emulsification of the alkoxylation product. The resultant dispersions and their use, for example as the basis for an adhesive or sealant, expressly form part of this application.

With increasing environmental awareness, the addition of organic solvents for lowering the viscosity of formulations used for surface modification has been criticized increasingly in recent years. Application of the prepolymers according to the invention in the form of an, advantageously aqueous, emulsion offers an alternative. Emulsions containing silyl functionalized prepolymers have been described in the literature. DE 2558653 (U.S. Pat. No. 3,941,733) describes emulsions from self-emulsifying polyurethanes bearing silyl groups and use thereof for the coating of surfaces. U.S. Pat. No. 4,376,149 describes emulsified mixtures of chain-end-silylated polyethers and OH-siloxanes and use thereof for the coating of textiles. DE 4215648 describes storage-stable contact adhesives based on solutions and/or emulsions of cationically modified, alkoxysilane-terminated polyurethanes. U.S. Pat. No. 6,713,558 and U.S. Pat. No. 6,831,128 describe water-dilutable emulsions of silylated elastomers and production thereof, WO 2007/072189 (US 2008-275176) and WO 2008/090458 describe emulsions of polymers bearing silyl groups.

Therefore aqueous emulsions represent another application of the compounds bearing alkoxysilyl groups of formula (I).

The aqueous phase of the emulsions can contain hydrophilic, inorganic fillers for modifying the mechanical properties of the coatings according to the invention, provided that these hydrophilic fillers are added subsequently to the already stabilized emulsion. It can be advantageous if the surface of the fillers used has at least one functional group, so that after drying and/or breaking of the emulsion, chemical reactions take place between reactive functional groups of the alkoxylation product of formula (I) with those on the surface of the filler. Examples of said fillers are pyrogenic and precipitated silica, inorganic oxides such as aluminium oxide, titanium dioxide and zirconium dioxide, glass and quartz, hydroxides such as aluminium hydroxide and magnesium hydroxide, silicates such as wollastonite, mica, kaolin and talc, calcium carbonate and other carbonates, metals such as copper, zinc and nickel and metal alloys and graphite and carbon black. Furthermore, the emulsion can contain low-molecular, organofunctional and water-insoluble silanes, as described previously. The emulsion can also contain the catalysts described previously for fixing the alkoxylation product on a surface.

Another object of the invention is the production of flame-retardant thermoplastic polymer compounds or thermosetting moulding compounds containing the alkoxylation products of formula I, which can in addition contain flame-proofing and/or flame-retardant substances such as for example ATH (aluminium trihydrate=aluminium hydroxide=aluminium trihydroxide), MDH (magnesium dihydroxide), hydromagnesite or melamine cyanurate. Polymer compounds of this kind are used for example for the production of cable insulation materials based on polypropylene, polyethylene or ethylvinyl acetate for cables and cable sheathing or flameproof partitions are produced e.g. based on polypropylene, which are subject to particularly stringent requirements in public buildings, e.g. sports halls.

The resultant flameproofed mixtures and compounds or also electric cables optionally display improved mechanical stability, improved dispersion of further additives, good extrudability even at a high degree of filling with particulate additives (for example with talc, calcium carbonate, etc.) and improved flame retardancy and optionally less smoke production when strongly heated. Especially when using alkoxylation products that have siloxane groups, the silicon content can provide additional stability in a fire, because after burning, there is still a proportion of SiO₂ remaining, which has an additional stabilizing and fire-retardant action. Moreover, even during burning, a so-called skin forms at an earlier point of time, reducing the further increase in temperature of the mixture and thus inhibiting propagation of the fire, which is especially relevant e.g. in the case of cables leading from room to room.

If these compositions according to the invention are to be expandable, they contain one or more blowing agents, optionally chemical or with physical action.

The surfaces to be coated can be coated by known means such as spraying, painting, dipping, etc. The surfaces that are to be glued are preferably pressed together in this method. The optionally foamable mixture for gluing is preferably applied from a pressurized can, with foam formation taking place on account of the blowing agent contained in the mixture, optionally also released by chemical reaction. The production and use of adhesive foams is described in more detail in document DE 10 2008 043218 (US 2010-071849).

Therefore another object of the invention is a foamable hardenable composition containing at least one compound of formula (I) and at least one chemical or physical blowing agent, which is expanded to a foam between the surfaces that are to be glued, or alternatively the foam that can be produced from the mixture after expansion is applied on one of the surfaces that are to be glued or between the surfaces that are to be glued, and the foam is then compressed between the surfaces that are to be glued.

Suitable blowing agents are gases that are already condensable at relatively low pressures, which are also used for the production of sprayable assembly foams. Common blowing agents are for example hydrocarbons with in each case 1 to 5, in particular 3 to 5 carbon atoms, in particular propane-butane mixtures or isobutane, fluorohydrocarbons with 1-5 carbon atoms, e.g. 1,1,1,2-tetrafluoroethane or 1,1-difluoroethane, or dimethyl ether and corresponding mixtures. The content of blowing agent is preferably <10 wt. %, especially preferably <7 or <5 wt. % relative to the total mixture.

Preferably the content of blowing agent relative to the total mixture is at most 10 wt. % and especially preferably at most 7 wt. %.

Foam formation can also take place without addition of a blowing agent, on a purely chemical basis, although preferably in the case of warm or hot curing. On heating the adhesive mixture, a blowing agent of low volatility is formed, which comprises for example alcohols such as methanol, ethanol, which arose from hydrolysis of the alkoxysilyl group. Water or an inert solvent can also serve as blowing agent at elevated temperature.

If coating of a substrate is required, the blowing agent can simply be omitted, and optionally the material properties required for the coatings can be provided by adding solvents or further additives and aids. The present invention therefore also relates to a method for the coating or modifying of surfaces, in which a composition, which contains the alkoxylation product with at least one other aminosilane compound or vinylsilane compound, is applied to the surface to be treated and is cured.

Surfaces of solid or also porous particles can be surface-coated according to the invention with methods known from the prior art. These include spraying of the alkoxylation product on the particles during for example mixing, kneading and/or heating optionally in the presence of suitable crosslinking catalysts. The alkoxylation products according to the invention can also be applied purely or from suitable organic and/or inorganic solvents on the particle surfaces, where they can then react, forming covalent bonds. It is also possible for emulsions of the alkoxylation products of formula (I) according to the invention in suitable media, optionally with addition of aids, other modifying agents and emulsifiers and/or wetting agents, to be applied to the particle surfaces. Particle surfaces can also be modified in a matrix of (pre)dispersed particles, for example of particulate fillers or functional particles (pre)dispersed in a polymer or a paint, by adding the alkoxylation product to the corresponding systems and mixing thoroughly, optionally with heating and/or addition of a suitable catalyst. In each case other components as well, for example monomeric, oligomeric or polymeric silanes or other components bearing reactive silyl groups and materials that harden or become attached by some other mechanism, for example acrylates, epoxides, isocyanates, carboxylates, hydroxides, lactones, lactams and many others, can be added to the alkoxylation products. Also, several of the alkoxylation products can be used mixed together.

The particles to be modified, of varying origin, different size or particle size distribution and different morphology (spherical, lamellar (with different aspect ratios), fibrous, aggregated as fractals, of cubic or cuboid shape etc.) and various states of agglomeration, include for example oxide particles, such as pyrogenic silica, for example AEROSIL®s from EVONIK Degussa GmbH, precipitated silicas, for example SIPERNAT®s from EVONIK Degussa GmbH, quartz particles and other inorganic oxide particles, such as glass particles, titanium dioxide, e.g. AEROXIDE® TiO₂ P25 and AEROXIDE® TiO₂ P90 from EVONIK Degussa GmbH, aluminium oxide, e.g. AEROXIDE® Alu C from EVONIK Degussa GmbH, zirconium dioxide and/or cerium dioxide, iron oxides, copper oxides and many others, silicate particles such as for example particles of kaolin, wollastonite, talc, mica, feldspars and many others, hydroxides such as aluminium trihydroxide and/or magnesium dihydroxide, boehmite, hydrotalcite and hydroxide-type iron pigments, for example FeO(OH), carbonates, for example calcium carbonate and/or dolomite, metals such as iron, copper, zinc, nickel, aluminium, magnesium and many others, metal alloys and/or carbon-containing materials, for example graphite and/or carbon black and many others. Particles e.g. of silicone resins, organomodified silicones, organic polymers and/or biopolymers, organic polyelectrolytes, melamine cyanurate and many others can be used as organic particulate substrates.

The various particles can also be surface-modified in the mixture.

The ratio of particle mass to surface modifier depends on the accessible particle surface, the desired degree of modification and the molecular weight of the modifying agent. Relative to the mass of the particles to be modified, the modifying agent according to the invention can be in the mass ratio of particle mass to mass of modifying agent in the range from 1:10 to 1 000 000:1, preferably from 1:1 to 10 000:1 and especially preferably in the range from 2:1 to 1000:1.

If we consider the particle weight relative to the total mixture that is used for surface modification, consisting of compositions containing the alkoxylation product or products, optionally catalyst, solvent, further silane compounds, and other additives, the weight ratio of particle weight:modifying mixture can be in the range from 1:1000 to 100 000:1, preferably in the range from 1:100 to 1000:1, especially preferably in the range 2:1 to 1000:1.

Macroscopic surfaces can also be coated with the alkoxylation products by the methods that are known from the prior art. In this case the alkoxylation products can be used for surface modification either in pure form or else mixed with further components, e.g. inorganic and/or organic solvents, reactive components such as mono-, oligo- or polymeric silanes, acrylates, epoxides, hydroxy compounds, amines and many others, as well as other coating components or aids.

The alkoxylation products can be applied in pure form, in organic or inorganic solvents, as aqueous emulsions or in combination with modifying agents functionalized in other ways, for example epoxides, acrylates, amines, isocyanates, urethanes and/or other polymers, such as mixtures of the alkoxylation products with monomeric silanes, for example aminosilanes and vinylsilanes and/or other polymers bearing silyl groups.

The modification of macroscopic surfaces with the materials described can be carried out for example with the methods known from the prior art such as dip-, spray- or spin-coating, flow coating, nebulizing, brush application, roller application, printing, screen printing, stamping and—with suitable consistency of the recipes according to the invention used for surface modification—also by powder coating techniques. Furthermore, it is also possible for emulsions of the alkoxylation products in suitable organic and/or inorganic solvents, optionally with addition of other substances, e.g. coating components, aids, for example wetting agents, emulsifiers and/or rheology additives, and fillers and/or functional particles, to be used for modification of the surfaces.

This makes it possible to modify a wide range of different surfaces, consisting for example of metal oxides, mixed oxides, nitrides, hydroxides, carbides, carbonates, silicates, pigments, blacks, elements or alloys as well as surfaces of organic materials. Furthermore, the surfaces of organic particles, such as of silicone resins, organomodified silicones, organic polymers or biopolymers, are amenable to surface modification.

Examples of such surfaces are macroscopic and microscopic surfaces such as surfaces of glass, paints, metals, semiconductor materials, oxide materials such as stone, concretes or mortars, wood, organic and inorganic fibres, fabrics and particles, polymers, biopolymers and many others.

Thus, the alkoxylation products can serve for example as raw materials for the production of adhesives, as reactive crosslinking agents, as adhesion promoters and primers and as binders for metals, glass and glass fibre/glass cloth, wood, wood materials, natural fibres, for the finishing and treatment of optionally textile fabrics and fibres from natural and/or synthetic and mineral raw materials and for example also cork, leather, paper, tissue, silicate and oxide materials.

There are many varied possible applications of these modified moulded articles, surfaces or particle surfaces. Thus, particles treated in this way can be used for example as fillers for polymers or the production of polymer compounds, nanocomposites and masterbatches. A good review of functional fillers used in polymers can be found in “Functional Fillers for Plastics”, edited by Prof. Dr. Marino Xanthos, WILEY-VCH Verlag GmbH & Co. KgaA, Weinheim, 2005, ISBN 3-527-31054-1. The alkoxylation products according to the invention can then be employed either by modifying the particles in question in a preliminary process and then dispersing them in the polymer, or it is also possible to add the alkoxylation products to the polymer in question during dispersion of the fillers, for example by adding them in liquid form in the extruder and including a subsequent effective dispersion section. Surprisingly, as a rule it is possible to modify the surface of particles with the alkoxylation products of formula I without agglomeration or aggregation of the particulate materials to be modified, despite the multifunctional character of the alkoxylation product of formula I. Furthermore, surface-modified particles according to the invention can be used for example as fillers or functional additives in paints, polymer compounds, nanocomposites, masterbatches or liquid pastes, polymer foams, organic resins or silicone resins, optionally with reactive binding to the respective matrices, as melt-flow-index improvers in injection moulding applications, for achieving physical effects on surfaces, e.g. superhydrophobicity, temperature-dependent wettability, water repellency, influence on soiling behaviour and soil removing behaviour on solid surfaces on building structures, textiles or fibres and the adherence of condensates and ice on surfaces and particles coated according to the invention, as glidants or lubricants, in sealing and sizing, for achieving haptic effects, for example a silky feel (soft-touch surfaces) or a specified surface feel or roughness (grip), as matting agent, as points of attachment for other materials, for example other coating materials, as adsorbents or absorbents for example in paper or filter materials or substances, as self-dispersing particles for the preparation of dispersions, as particulate emulsifiers (for so-called “Pickering Emulsions” (cf. “Emulsions”, Spencer Umfreville Pickering, Journal of the Chemical Society, Transactions (1907), 91, 2001-2021), as reactive and/or crosslinkable particles, optionally dispersed in liquid media, as active components in defoamers, in masonry water repellents, for example as active components for integral mass hydrophobization, as structured, hydrophobic components for surface hydrophobization or as carriers for active, liquid components, as (optionally reactive) encapsulating agents, for example for core-shell particles or for microencapsulation of liquid systems, for modification of membrane materials, for example for achieving a specified, adjustable porosity, selectivity or permeability, as antistatic additives, for example after hydrophilic or hygroscopic particle surface modification, as flow aids, as additives for providing or improving scratch resistance of materials or surfaces provided with the particles or as particulate additives with additional functions, for example as microbicidal additives, as fluorescent markers or as effect pigments, as parting agents, as constituents for low-temperature-resistant cable coatings, as components in the manufacture of rubber articles and membranes, as size or ingredients for sizes in the textile and glass fibre industry, for paper, as additives for toner, as abrasives or wrinkle concealers in cosmetics, as constituents of formulations or carriers that release active substances or auxiliary products over a long period, the substances to be released being for example cosmetic oils and active substances, odorants, pharmaceutical active substances, antimicrobial active substances, and for example silver and silver-containing compounds, and colorants and preservatives can be present in the particles, and many others.

The alkoxylation products according to the invention can be used alone or as additives in aqueous systems for treating the stated flat materials and fibres and thus make it possible to use the treated moulded articles, flat materials and fibres in the areas of hygiene, medicine, building, motor vehicles, household textiles, textiles for clothing, sports and agriculture.

The resultant surface-modified particles or flat materials are thus provided with novel or optimized properties, for example with respect to softness, slip, water transport/uptake, water/oil repellency, UV protection, self-cleaning (lotus effect), e.g. for awnings, flame retardancy, increased strength with maximum possible flexibility, antistatic properties, resistance to bacteria, viruses, chemicals.

The invention therefore further relates to the aforementioned coated articles produced using the compositions containing the alkoxylation products according to the invention, for example surfaces, moulded articles, particles, fabrics, cloths and similar materials.

The invention further relates to sealant compounds and/or adhesive compounds containing the alkoxylation products according to the invention, where a surface coating can itself provide sealing or gluing, and these sealant compounds and/or adhesive compounds can in particular also contain glidants, for example MoS₂ or PTFE particles.

Furthermore, the alkoxylation products according to the invention can also find application in the production of electrical and/or electronic components, for example also OLEDs and solar panels. Conductive particles or ionic liquids can be contained as additives and so permit their use in conductive coatings and conductive adhesives, for example in circuit board conductors, for contacts and/or antistatic finishing.

The invention further relates to composites, for example wood-plastic composites (WPC) that are made using the compounds of formula (I). WPCs are thermoplastically processable composites, which consist of various proportions of wood, plastics and additives, and can be processed by thermoplastic forming techniques, e.g. extrusion, injection moulding or pressing techniques. Compared with polypropylene-maleic anhydride-grafted copolymers, the novel silylpolyether composites have improved bonding to the wood or fibre main constituent of these materials. The alkoxylation products bind to fibres based on wood, coconut or other naturally available fibrous products with simultaneous hydrophobization of the surface and therefore guarantee reduced drying time of the wood-fibre pellets (energy saving!). In contrast to ordinary inorganic fillers, low-molecular products can exert a very good compatibilizing action, for in rapid extrusion processes they can be distributed homogeneously in seconds, faster than the PP-MAA polymers.

The invention further relates to powder coating hardeners with defined glycidyl functionality and improved compatibility and/or improvement of adhesion to the substrate, thus reducing under-film corrosion in powder coating of exterior walls. Improvement of adhesion is particularly important in the case of oxide or silicate surfaces, for example mortar, screed or cement.

The invention further relates to liquid pastes, in which the alkoxylation products according to the invention are used on their own, for example instead of a usual polyether polyol (PPG 1000), which generally requires the additional use of a dispersing agent, since the alkoxylation product of formula (I) combines the properties of both substances. These pastes, which contain pigments as colorants or optionally can contain additional colouring matter and other additives, are used for colouring polyol-based systems, for example PU foams, thermoplastic urethanes or the like.

Another object of the invention is the use of the alkoxylation product and formulations prepared from it for example also for the production of cosmetics. Thus, the products according to the invention can be used in a formulation for the permanent or non-permanent treatment of the skin, hair or skin appendages, for example to achieve an especially durable positive sensory effect. Products are especially advantageous that interact with organic substrates via especially hydrophobic segments or via cationic monomers, and therefore can simply be deposited on them. The alkoxysilyl function can, through reactions with OH groups of the surface of the skin or hair, provide permanent binding to these surfaces.

The alkoxylation products according to the invention can also be used as additives in lacquer or nail varnish formulations.

A modern nail varnish or a nail coating composition serves for providing an attractive shape and coloration of fingernails and toenails. In addition, the nail is protected against environmental effects and there is hardening of the nail plate or the nail surface. Special efforts are made to provide nail varnish coatings that are durable, resistant to cracking and splintering, shiny, in attractive colours and gloss. Nail varnishes (therefore) contain a large number of the most varied ingredients, those that are especially important being film formers, adhesion promoters, plasticizers, solvents and pigments. Pyrogenic silica is used as a rheology and thixotropy modifier. U.S. Pat. No. 4,873,077, GB 1177420 and DE 69111621 describe a large number of additives for ensuring good wearing resistance, good chipping, nail breakage and tearing prevention and durability after drying of the nail varnish as a flexible, adherent, hard film on the nail. Furthermore, with the alkoxylation products according to the invention it is also possible to produce special physical effects on solid substrates, such as hydrophobic or hydrophilic surface properties. Moreover, said effects can also still be subject to an additional stimulus, for example the prevailing temperature. As is known from the literature, polyethers in water have so-called cloud points, which are temperature dependent and result from incompatibility with the surrounding medium as the temperature rises. It was shown that binding of silyl-modified polyether chains to various surfaces can make their contact angle with various liquids, for example water, temperature-dependent.

For the compositions according to the invention, there are numerous various applications in the area of adhesives, sealants, binders and joint sealants. Moreover, they are suitable for numerous different substrates, e.g. mineral substrates, metals, plastics, glass, ceramic, wood, wood materials, natural fibres, skin, hair, skin appendages, horn or also cork etc. In principle, the compositions or the foams produced from them are suitable for gluing any objects. In particular, however, they are very suitable when the surfaces to be glued together are uneven or when finely-divided fibres or particles, as well as cork for example, are to be joined together to form a composite. This applies for example to the gluing of fracture surfaces that no longer fit together exactly because of chipping or warping of the material, or when gluing skirting boards, covering strips or other decorations on an uneven wall surface. Here, the foams have the advantage that they also provide good filling of cavities.

The modified alkoxylation products according to the invention and the corresponding methods for production thereof are described below as examples, but the invention is not to be regarded as being limited to these examples of embodiments.

If ranges, general formulae or classes of compounds are given below, these are not intended only to comprise the corresponding ranges or groups of compounds that are mentioned explicitly, but also all partial ranges and partial groups of compounds that can be obtained by removal of individual values (ranges) or compounds.

If documents are cited within the scope of the present description, the contents thereof are included in their entirety in the disclosure contents of the present invention.

The invention is further described by the following non-limiting examples which further illustrate the invention, and are not intended, nor should they be interpreted to, limit the scope of the invention.

### EXAMPLES

Production of polyether alcohols bearing alkoxysilyl groups by the method according to the invention using DMC catalysts. OH numbers were determined by the cold acetylation method based on analysis specification C-V 17A (98) of the “German Society for Fats Science” (Deutsche Gesellschaft für Fettwissenschaft, DGF). The average molecular weights were determined from the OH numbers or by GPC. The epoxide oxygen content of the end products was determined in the presence of conc. HCl by the back titration principle with sodium hydroxide solution. The viscosity of the products was determined using a rheometer (MCR 301, Anton Paar). A plate/plate geometry with a diameter of 50 mm was used for measurement. The GPC measurements for determining the polydispersity and average molecular weights were obtained under the following measuring conditions: column combination SDV 1000/10 000 Å (length 65 cm), temperature 30° C., THF as mobile phase, flow rate 1 ml/min, sample concentration 10 g/l, RI detector, evaluation against polypropylene glycol standard.

### Example 1

### Alkoxysilylated Alkoxylation Product with Methyl Residue in the Alpha Position to the Hydroxyl Group—Not According to the Invention

Production of polyether alcohols bearing alkoxysilyl groups using DMC catalysts according to the method disclosed in EP 2 093 244. The epoxide oxygen content of the end products was determined in the presence of conc. HCl according to the back titration principle with sodium hydroxide solution.

A 3-litre autoclave is charged with 140 g of polypropylene glycol (average molecular weight 700 g/mol) and 0.22 g of zinc hexacyanocobaltate DMC catalyst under nitrogen and is heated to 130° C. with stirring. The reactor is evacuated to an internal pressure of 30 mbar, in order to remove any volatile components present by distillation. A small amount of propylene oxide is supplied for activation of the DMC catalyst and after 15 min and start-up of the reaction, 1032 g of propylene oxide is supplied at 130° C. within 1 h, with cooling. Then 111 g of 3-glycidyloxypropyltriethoxysilane (DYNASYLAN® GLYEO) and 1520 g of propylene oxide are supplied simultaneously at 100° C., continuously within 1.5 h with cooling. Further reaction for 90 minutes at 100° C. is followed by the degassing stage. The finished alkoxylation product is cooled to below 80° C. and is discharged from the reactor.

The alkoxylation product obtained contains 2 trialkoxysilyl units on average per molecule and has an average molecular weight of 14 000 g/mol. Free epoxy groups cannot be detected in the end product. The viscosity of the alkoxylation product, determined with a calibrated rheometer, at 25° C. and a shear rate of 10 l/s, is approx. 20-25 Pa*s.

The silyl polyether according to example 1, cured using an Sn catalyst (c: 0.3%) (dioctyl tin diketonate, TIB® KAT 223 (TIB Chemicals)) in the standard climate (T: 23° C., RH: 50%, 7 days), was tested in accordance with DIN 53 504 at a testing speed of 200 mm/min. The ultimate elongation determined was 55%±3%.

### Example 2

### Alkoxysilylated Alkoxylation Product with Ethyl Residue in the Alpha Position to the Hydroxyl Group—According to the Invention

A 3-litre autoclave is charged with 400 g of polypropylene glycol (average molecular weight 2000 g/mol) and 0.26 g of zinc hexacyanocobaltate DMC catalyst under nitrogen and is heated to 130° C. with stirring. The reactor is evacuated to an internal pressure of 30 mbar, in order to remove any volatile components present by distillation. A portion of 45 g of propylene oxide is supplied for activation of the DMC catalyst. After 20 min and start-up of the reaction, 732 g of propylene oxide is added within 40 min at 130° C. with cooling. Then 111 g of 3-glycidyloxypropyltriethoxysilane (DYNASYLAN® GLYEO) and 1520 g of propylene oxide are supplied simultaneously, continuously within 1.5 h at 110° C., with cooling. After a holding time of 30 min, 89 g of butylene oxide is supplied at 110° C. Further reaction for 90 min at 110° C. is followed by the degassing stage. The finished alkoxylation product is cooled to below 80° C. and is discharged from the reactor.

The alkoxylation product obtained contains 2 trialkoxysilyl units on average per molecule and has an average molecular weight of 14 500 g/mol. Free epoxy groups cannot be detected in the end product. The viscosity of the alkoxylation product, determined with a calibrated rheometer, at 25° C. and a shear rate of 10 l/s, is approx. 22-30 Pa*s. The silyl polyether according to example 2, cured using an Sn catalyst (c: 0.3%) (dioctyl tin diketonate, TIB® KAT 223 (TIB Chemicals)) in the standard climate (T: 23° C., RH: 50%, 7 days), was tested in accordance with DIN 53 504 at a testing speed of 200 mm/min. The ultimate elongation determined was 103%±3%.

### Example 3

### Alkoxysilylated Alkoxylation Product with Ethyl Residue in the Alpha Position to the Hydroxyl Group—According to the Invention

A 3-litre autoclave is charged with 400 g of polypropylene glycol (average molecular weight 2000 g/mol) and 0.26 g of zinc hexacyanocobaltate DMC catalyst under nitrogen and is heated to 130° C. with stirring. The reactor is evacuated to an internal pressure of 30 mbar, in order to remove any volatile components present by distillation. A portion of 45 g of propylene oxide is supplied for activation of the DMC catalyst. After 20 min and start-up of the reaction, 732 g of propylene oxide is supplied within 40 min at 130° C., with cooling. Then 111 g of 3-glycidyloxypropyltriethoxysilane (DYNASYLAN® GLYEO) and 1520 g of propylene oxide are supplied simultaneously, continuously at 85° C. within 1.5 h, with cooling. After a holding time of 30 min, 89 g of butylene oxide is supplied at 85° C. Further reaction for 90 min at 85° C. is followed by the degassing stage. The finished alkoxylation product is cooled to below 80° C. and is discharged from the reactor.

The alkoxylation product obtained contains 2 trialkoxysilyl units on average per molecule and has an average molecular weight of 14 500 g/mol. Free epoxy groups cannot be detected in the end product. The viscosity of the alkoxylation product, determined with a calibrated rheometer, at 25° C. and a shear rate of 10 l/s, is approx. 16-25 Pa*s. The silyl polyether according to example 2, cured using an Sn catalyst (c: 0.3%) (dioctyl tin diketonate, TIB® KAT 223 (TIB Chemicals) in the standard climate (T: 23° C., RH: 50%, 7 days), was tested in accordance with DIN 53 504 at a testing speed of 200 mm/min. The ultimate elongation determined was 86%±3%.

For the storage tests, the alkoxysilylated alkoxylation product was mixed (c(catalyst): 0.5 wt. %) with a dibutyl-Sn-diketonate (TIB® KAT 226 (TIB Chemicals)) or with a dioctyl-Sn-diketonate catalyst (TIB® KAT 223). If necessary, vinyl-trimethoxysilane (available e.g. as DYNASYLAN® VTMO (Evonik Industries)) was also added as a chemical drying additive. The materials were mixed in a mixer (Speedmixer DAC 600 FVZ (Hausschild)) for 60 s (2300 rev/min), and then transferred to Euro-cartridges (Ritter) and sealed with a suitable plug. After storage at room temperature for one day, the cartridges were warmed in a drying cabinet to 60° C. and were stored at this temperature. After different periods of time, a cartridge was opened and tested for partial crosslinking of the contents. This is done by squeezing out the material and assessing its flowability. If a definite increase in viscosity above 100 Pa*s and/or a loss of flowability is observed, the material is assessed as partially crosslinked.

TABLE 1
Result of the storage tests of the alkoxylation product mixed with catalyst
and optionally drying agent

| | |
|---|---|
| Additive | Storage stability |

Product according to example 1—not according to the invention

| | |
|---|---|
| +catalyst | 1-2 days |
| +VTMO + catalyst | 3 days |

Product according to example 2—according to the invention

| | |
|---|---|
| +catalyst | 10 days |
| +VTMO + catalyst | 14 days |

Product according to example 3—according to the invention

| | |
|---|---|
| +catalyst | 12 days |
| +VTMO + catalyst | 18 days |

In the case of alkoxylation products that were provided terminally according to the invention with an oxybutylene, there is greatly improved storage stability in the presence of catalyst. When formulated, these alkoxylation products also display greatly improved storage behaviour, characterized by later gelation of the formulation. The storage time to gelation of the formulations with the alkoxylation products prepared according to the invention increased to 7-10 days (see Table 1). If, as in example 3, the alkoxylation product is prepared at 80° C. to 100° C. in the last reaction step, it can be stored with catalyst and at 60° C. also for approx. 12 days, and with added drying agent even for 18 days. This therefore represents a marked improvement compared with the original alkoxylation products of the prior art and makes use possible for the first time in the formulations and applications mentioned in the above examples.

Surprisingly, it was observed that the elongation behaviour of the products crosslinked by hydrolysis-condensation can be greatly improved by the structures according to the invention. Thus, there is a marked improvement in ultimate elongation of the polymers. Whereas an ultimate elongation in extension of 55% was observed for the products described in example 1, an ultimate elongation in extension of 103% was achieved for the products prepared in example 2.

The following examples can be given for a formulation according to the invention of the alkoxylation products according to the invention, but application of this invention is expressly not limited to these examples.

TABLE 2
Hardenable Formulation 1:

| | Proportion by weight |
|---|---|
| | in the total |
| Constituent | formulation |
| Alkoxylation product according to | 29.2 wt. % |
| example 2 | |
| Diisoundecylene phthalate | 15.0 wt. % |
| (plasticizer) | |
| Omyacarb ® 2 GU (filler) | 50.0 wt. % |
| Vinyl trimethoxysilane (drying | 0 wt. % or 1.0 wt. % |
| agent) | |
| Oligomeric aminosilane [Dynasylan ® | 1.5 wt. % |
| 1146] (adhesion promoter) | |
| Pyrogenic silica [Aerosil ® R202] | 3.0 wt. % |
| (rheology additive) | |
| Dioctyl tin diketonate [TIB ® KAT | 0.3 wt. % |
| 223] (catalyst) | |

TABLE 3
Hardenable Formulation 2:

| | Proportion by weight |
|---|---|
| | in the total |
| Constituent | formulation |
| Alkoxylation product according to | 30.25 wt. % |
| example 2 | |
| Diisoundecylene phthalate | 7.5 wt. % |
| (plasticizer) | |
| Socal ®U1S2 (filler) | 55.7 wt. % |
| Vinyl trimethoxysilane (drying | 0 wt. % or 0.75 wt. % |
| agent) | |
| Aminosilane [Dynasylan DAMO] | 0.5 wt. % |
| (adhesion promoter) | |
| Oligomeric aminosilane [Dynasylan ® | 1.5 wt. % |
| 1146] (adhesion promoter) | |
| Irganox ® 1135 (stabilizer) | 0.5 wt. % |
| Pyrogenic silica [Aerosil ® R202] | 3.0 wt. % |
| (rheology additive) | |
| Dioctyl tin diketonate [TIB ® KAT | 0.3 wt. % |
| 223] (catalyst) | |

TABLE 4
Hardenable Formulation 3:

| | Proportion by weight |
|---|---|
| | in the total |
| Constituent | formulation |
| Alkoxylation product according to | 22.2 wt. % |
| example 2 | |
| Alkane sulphonic acid phenyl ester | 21.0 wt. % |
| [Mesamoll ®, Bayer] (plasticizer) | |
| Sikron ® SF600 (filler) | 49.5 wt. % |
| Vinyl trimethoxysilane (drying | 0 wt. % or 1.0 wt. % |
| agent) | |
| Oligomeric aminosilane [Dynasylan ® | 1.5 wt. % |
| 1146] (adhesion promoter) | |
| Amide wax [Crayvallec ® SLX] | 3.5 wt. % |
| (rheology additive) | |
| Tinuvin ® 292 (stabilizer) | 0.5 wt. % |
| Tinuvin ® 1130 (stabilizer) | 0.5 wt. % |
| Dioctyl tin diketonate [TIB ® KAT | 0.3 wt. % |
| 223] (catalyst) | |

TABLE 5
Hardenable Formulation 4:

| | Proportion by weight |
|---|---|
| | in the total |
| Constituent | formulation |
| Alkoxylation product according to | 22.2 wt. % |
| example 3 | |
| Alkane sulphonic acid phenyl ester | 21.0 wt. % |
| [Mesamoll ®, Bayer] (plasticizer) | |
| Sikron ®SF6OO (filler) | 49.5 wt. % |
| Vinyl trimethoxysilane (drying | 0 wt. % or 1.0 wt. % |
| agent) | |
| Oligomeric aminosilane [Dynasylan ® | 1.5 wt. % |
| 1146] (adhesion promoter) | |
| Amide wax [Crayvallec ® SLX] | 3.5 wt. % |
| (rheology additive) | |
| Tinuvin ® 292 (stabilizer) | 0.5 wt. % |
| Tinuvin ® 1130 (stabilizer) | 0.5 wt. % |
| Dioctyl tin diketonate [TIB ® KAT | 0.3 wt. % |
| 223] (catalyst) | |

The components of the stated formulations are incorporated by the methods known by a person skilled in the art, paying particular attention to exclusion of moisture and formulation avoiding air inclusions. This is usually achieved by formulation under vacuum.

If the formulations prepared with the alkoxylation products are now compared, it is observed, surprisingly, that the alkoxylation product prepared in example 3, at the lower GlyEO adduct formation temperature compared with example 2, permits improved hardening of the formulation. Thus, with the formulation presented in Table 5, skin formation can be observed after about 20 minutes, whereas under the same conditions, the formulation presented in Table 4 takes about 35-40 minutes for skin formation. In contrast, the ultimate elongation of the cured formulation from Table 4 is not adversely affected.

Having thus described in detail various embodiments of the present invention, it is to be understood that the invention defined by the above paragraphs is not to be limited to particular details set forth in the above description as many apparent variations thereof are possible without departing from the spirit or scope of the present invention.

Further objects of the invention follow from the claims, the disclosure contents of which form part of this description in their entirety.

1. An alkoxylation product of general formula (I) 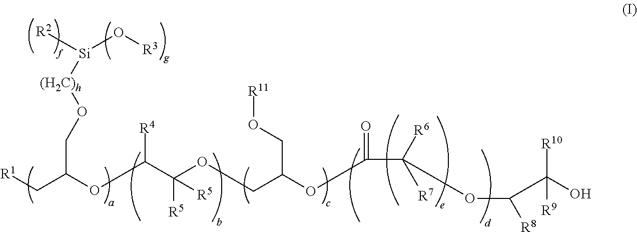
in which
R¹=a 1- to 6-fold functional saturated or unsaturated, linear or branched organic residue of the type of an alkoxy, arylalkoxy or alkarylalkoxy group, for which the carbon chain can be interrupted by oxygen atoms and can also bear substituents containing alkoxysilyl side groups or is substituted directly with alkoxysilyl groups, selected from the group comprising polyoxyalkylene residues, polyether residues, a polyetheralkoxy residue
or corresponds to a singly or multiply annelated phenolic group,
or can be derived from a singly or multiply hydroxylated or multiply substituted compound selected from the group comprising alcohols, polyetherols, polyesterols, siloxanes, perfluorinated polyetherols, (poly)-urethanes or sugars,
R²=an alkyl group with 1 to 8 carbon atoms,
R³=an alkyl group with 1 to 8 carbon atoms,
R⁴=a hydrogen radical or an alkyl group with 1 to 8 carbon atoms,
R⁵=independently of one another a hydrogen radical, an alkyl group with 1 to 20 carbon atoms, an aryl or alkaryl group,
R¹¹=a saturated or unsaturated alkyl group with 1 to 8 carbon atoms, whose chain can be interrupted by oxygen and can bear further functional groups, carboxyl groups or ester groups, an aryl group with 6 to 20 carbon atoms, an alkaryl group with 7 to 20 carbon atoms, an allyl group or a polyacrylic acid ester
R⁶ and R⁷=independently of one another are equal to R⁵,
R⁸ and R⁹=independently of one another are equal to R⁴
R¹⁰=R⁴ with the proviso
that if R⁹=H, R¹⁰ is equal to an alkyl group with 2 to 8 carbon atoms and if R⁹=methyl, then R¹⁰ is an alkyl group with 1 to 8 carbon atoms, in any case different from hydrogen;
a=0 to 1000, provided that “a” must be greater than or equal to 1, if substituent R¹ does not bear alkoxysilyl groups or itself is not directly substituted with alkoxysilyl groups,
b=0 to 1000,
c=independently of one another equal to b,
d=independently of one another equal to b,
provided that the groups with the indices a, b, c and d can be freely permuted over the molecular chain,
e=1 to 10,
g+f=3 and g is at least equal to 1,
h=0, 1, 2, 3, 4, 5, 6, 7, 8, 9 or 10 and provided that
the various monomer units both of the fragments with the indices a, b, c, and d and of the polyoxyalkylene chain of the substituent R¹ can be constructed in blocks with one another or else are subject to a random distribution and moreover are freely permutable with one another.

2. The alkoxylation product of formula (I) according to claim 1 in which R¹ is a residue derived from polyols, EO-polyetherols, PO-polyetherols or EO/PO-polyetherols, polyesterols, glycerol, polyglycerol, polyTHF, phenol, alkyl and aryl phenols, bisphenol A, novolacs, hydroxycarboxylic acids, siloxanols, siloxane diols, castor oil, ricinoleic acid, sugar, lactones, cellulose, methanol, ethanol, n-, i-propanol, n-, i-, or t-butanol, 2-butanol, octanol, allyl alcohol, dodecanol, stearyl alcohol, 2-ethylhexanol, cyclohexanol, benzyl alcohol, ethylene glycol, propylene glycol, di-, tri- and polyethylene glycol, 1,2-propylene glycol, di- and polypropylene glycol, OH-functional polyolefins, OH-functional polybutadiene, 1,4-butanediol, 1,6-hexanediol, 1,4-butynediol, tetramethyldecinediol, trimethylolpropane, pentaerythritol, sorbitol, cellulose sugar, lignin or compounds based on natural substances and bearing hydroxyl groups,
which can itself also bear alkoxysilyl groups or bears substituents that bear alkoxysilyl groups.

3. The alkoxylation product of formula (I) according to claim 1, characterized in that an end block of alkoxylated butylene oxide —(C₄H₉O)ₙH with n=1 to 100 is present.

4. A method of producing the alkoxylation product of claim 1 comprising using DMC catalysis from starting compounds R¹—H bearing hydroxyl groups, in which, in an alkoxylation reaction, first optionally alkylene oxides, epoxy-functional alkoxysilanes, glycidyl compounds and/or lactones are added on in any order, characterized in that in a final alkoxylation step at least one monomer unit of an epoxide of formula (Ia) 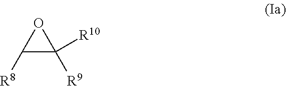
where
R⁸ and R⁹=a hydrogen radical or an alkyl group with 1 to 8 carbon atoms, preferably methyl or ethyl,
R¹⁰=a hydrogen radical or an alkyl group with 1 to 8 carbon atoms, preferably methyl or ethyl,
with the proviso
that if R⁹=H, then R¹⁰ is equal to an alkyl group with 2 to 8 carbon atoms and if R⁹=methyl, then R¹⁰ is an alkyl group with 1 to 8 carbon atoms, in any case different from hydrogen,
is added on to the OH function of the polymer chain.

5. The method according to claim 4, characterized in that butylene oxide or isobutylene oxide is used as epoxide in the last alkoxylation step.

6. A hardenable composition containing at least one compound of formula (I) according to claim 1.

7. A hardenable composition according to claim 6 containing at least one curing catalyst.

8. The hardenable composition according to claim 7 in the form of a solution, emulsion, dispersion or suspension, characterized in that they contain an emulsifier.

9. The hardenable composition according to claim 8 containing at least one further additive selected from the group comprising diluents, catalysts, plasticizers, fillers, solvents, emulsifiers, adhesion promoters, rheology additives, additives for chemical drying, and/or stabilizers against thermal and/or chemical stresses and/or stressing by ultraviolet and visible light, thixotropic agents, flame retardants, foaming agents or antifoaming agents, deaerators, film-forming polymers, antimicrobial agents and preservatives, antioxidants, colorants, dyes and pigments, antifreezes, fungicides, reactive thinners, chelating agents, wetting agents, co-crosslinkers, spraying aids, vitamins, growth promoters, hormones, pharmacological active substances, odorants, radical interceptors and/or other additives.

10. The hardenable composition according to claim 9 additionally containing at least one chemical or physical blowing agent.

11. An adhesive or sealant compound or coating agent containing a hardenable composition according to claim 6.

12. A moulded article, liquid paste, powder coating hardener, particle, fabric or composite material produced using the hardenable composition according to claim 6.

13. The moulded article according to claim 12 in the form of flame-retardant thermoplastic polymer compounds, flame-retardant partitions or cable coatings.

14. A method of sealing and/or glueing and/or foaming and/or for the coating of flat or particulate or fibrous substrate surface which comprises of adding the curable composition of claim 8 to the surface.

15. The method of claim 14 for the sealing and/or gluing and/or foaming and/or for the coating of porous or non-porous, particulate or flat substrates selected from the group consisting of constructional elements, components, metals and constructional materials, iron, steel, special steel and cast iron, ceramic materials containing solid metal or non-metal oxides or carbides, aluminium oxide, magnesium oxide or calcium oxide, and mineral substrates, organic substrates, composites, wood composites, cork, chipboard and fibreboard from wood or cork, MDF board, WPC articles, cork articles, laminated articles, ceramics, natural fibres, synthetic fibres, wood and combinations thereof.
